(19) United States
(12) Patent Application Publication
(10) Pub. No.: US 2004/0242199 A1
(43) Pub. Date: Dec. 2, 2004

(54) Mobile telecommunications networks

(76) Inventors: Peter Edlund, Tumba (SE); Himke Van Der Velde, Zwolle (NL)

Correspondence Address: JENKENS & GILCHRIST, PC, 1445 ROSS AVENUE, SUITE 3200, DALLAS, TX, 75202, US

(21) Appl. No.: 10/491,913

(22) PCT Filed: Sep. 25, 2002
(86) PCT No.: PCT/EP02/10748

(30) Foreign Application Priority Data
Oct. 18, 2001 (GB) 0125069.5

(51) Int. Cl. H04M 3/16

(52) U.S. Cl. 455/411

(57) ABSTRACT

A method is provided that serves to avoid unnecessary re-acquisition of preconfiguration information on a user changing from one public land mobile network (PLMN) to another.

The present invention relates to mobile telecommunications networks.

### BACKGROUND OF THE INVENTION

The present invention concerns handover from GSM to UTRA (UMTS Terrestrial Radio Access Network), which is one example of an inter Radio Access Technology (RAT) handover. It applies to both the UTRA-FDD and the UTRA-TDD modes of the standard as defined by 3 GPP.

FIG. 1 and the explanation below describe a network architecture in which the User Equipment (UE) is an UTRA mobile terminal by which a subscriber can access UTRA services offered by an operator's Core Network (CN). In this case, UE terminal is dual mode, also acting as Mobile Station (MS), which is a GSM mobile terminal by which a subscriber can access GSM services offered by the operator's Core Network (CN).

Referring to FIG. 1, the UTRAN (UMTS (Universal Mobile Telecommunications System) Terrestrial Radio Access Network) is the part of the network that is responsible for the radio transmission and control of the radio connection. The RNS (Radio Network Subsystem) controls a number of Base Stations in the radio access network. The RNC (Radio Network Controller) comprises an RNC and node B's controls radio resources and radio connectivity within a set of cells. The node B handles the radio transmission and reception within one or more cells.

On the GSM side, the corresponding nodes are as follows:

The BSC (Base Station Controller) controls radio resources and radio connectivity within a set of cells.

The BTS (Base Transmission Station) handles the radio transmission and reception within one or more cells of the GSM network.

An inter RAT handover procedure (ie. from GSM to UTRA or vice versa) is described as below, with reference to FIG. 2:

1. Upon a measurement report, the BSC initiates an inter RAT handover by sending a HANDOVER REQUIRED message to the CN.

2. The CN requests the target RNC to reserve resources to accommodate the handover by means of the RELOCATION REQUEST message.

3. The t-RNC confirms the reservation of resources by means of the RELOCATION REQUEST ACK message. This message includes a RRC HANDOVER TO UTRAN message, including the details of the UTRA radio resources to be used after handover.

4. Next, the CN orders the handover to be performed by sending the HANDOVER COMMAND message to the BSC. This message includes the RRC HANDOVER TO UTRAN message.

5. The BSC forwards the handover command, via the GSM air interface, to the UE by sending the INTER SYSTEM TO UTRAN HANDOVER COMMAND message. This message again includes the RRC HANDOVER TO UTRAN COMMAND message.

6. Upon successful completion of the handover, the UE sends the HANDOVER TO UTRAN COMPLETE message, via the UTRA air interface, to the t-RNC.

7. Finally the CN initiates release of the GSM radio connection.

The HANDOVER COMMAND message that is sent by the BSC across the GSM air interface to the MS is sent in segments of limited length (21 octets). Moreover, a subsequent segment can only be transferred after acknowledgement of the previously transmitted segment.

Inter RAT handover is normally initiated when the quality of the downlink radio connection falls below a certain level. The quality of the uplink radio connection may be considerably poorer. The HANDOVER COMMAND is sent from BSC to MS via the downlink radio connection. However, when segmented messages are used, successful transfer of the message requires that acknowledgements are transferred via the uplink radio connection. Thus, if segmentation is used it may be impossible to transfer quickly the handover message due to poor quality of the uplink radio connection. In other words, segmentation of the GSM air interface will have a significantly detrimental, and unacceptable, impact on handover performance.

The RRC HANDOVER TO UTRAN COMMAND message includes the details of the UTRA radio resources to be used after handover. It includes a large number of parameters. The size of this message, which depends on the actual content of these parameters, is typically of the order of 100 to 200 octets. Hence, the RRC message is normally far too large to be fitted within a non segmented GSM air interface message of 21 octets.

Pre-defined configurations have been defined as a means to reduce the size of the RRC HANDOVER TO UTRAN COMMAND message; a network may download/pre-define one or more radio configurations in a UE. A predefined radio configuration mainly includes a large number of radio-bearer, transport channel, and some physical channel parameters. Prior to handover, UTRAN obtains information about which configurations are stored in the UE. In the case that the UE has suitable predefined configurations stored, UTRA network can refer to the stored configuration and only needs to signal a few additional parameters. In addition, a number of default configurations are defined in the relevant standards and these default configurations can be used in a similar manner. Since they do not need to be downloaded, the default configurations can always be used by the UTRAN.

Furthermore, for several parameters it has been agreed that it is not essential that they are included in the handover message. The implication is that, when using pre-defined configurations, the corresponding functionality cannot be configured immediately upon handover.

Finally, for some of the parameters transferred when using preconfiguration, the use of a smaller value range has been agreed. This further helps to reduce the size of the message, although there can be a slight performance degradation.

The concept of Equivalent PLMNs (Public Land Mobile Networks) has been defined to facilitate sharing of infrastructure between operators; it allows UEs that have a subscription with one operator to access the network of another operator, identified by another PLMN identity.

An “equivalent PLMN” is a PLMN that is considered to be equivalent to the selected PLMN by the UE for cell selection/reselection and Inter PLMN Handover. Thus, when performing cell re-selection, the UE shall regard PLMNs included in the list of equivalent PLMNs as equivalent to the current PLMN.

If used, the non-access stratum message is used to provide the list of equivalent PLMNs to the UE. Furthermore, the access message (RRC) may broadcast the PLMN identities of neighbouring cells to be considered for cell (re-)selection.

When equivalent PLMNs are used, it is likely that UEs change to another PLMN either by cell reselection, cell selection or Intra PLMN handover. Currently it is specified that a UE shall consider all information for one PLMN to be invalid upon change to another PLMN. As a result, the UE will need to reacquire the system information from the new PLMN. Since some system information is scheduled infrequently, this may take up to 40 sec. Moreover, the mobile may not be able/required to read the information in all scenarios. For example, when in UTRA mode, reading of system information is not required in CELL_DCH state, when in GSM connected mode, reading of system information from neighbouring UTRAN cells is not required. The drawback of this lengthy re-acquisition time is twofold:

Increase in power consumption

Procedures that require the system information are delayed or have to cope without availability of the information, in which case functionality or performance may be degraded

The following system information blocks are PLMN specific:

SIB (system information block) type 1, which contains NAS (non-access stratum) system information as well as UE timers and counters to be used in idle mode and in connected mode

SIB type 15.3, which contains information useful for ionospheric delay, UTC offset, and Almanac data. These IEs (information elements) contain information extracted from the subframes 4 and 5 of the GPS navigation message

SIB type 16, which contains pre-defined configurations to be stored by UE in idle and connected mode for use during handover to UTRAN. His information is specified in TS 25.331 (3 GPP Technical Specification)

It is possible to support inter PLMN inter RAT handover to UTRAN, either by specifying the complete radio configuration or by using default configurations.

A complete UTRA radio configuration results in a large GSM handover message, which transfer will require multiple segments across the GSM air interface. This transfer will fail if the uplink is of poor quality, since each-segment needs acknowledgement before the next can be sent. Hence use of the complete specification approach may result in poor handover performance.

Currently 10 default configurations are defined in the standard. In general, these configurations represent stable and reliable configurations that will work in most cases. However, it is likely that these configurations are far from optimal in many system configurations, which means a reconfiguration will be needed shortly after handover. Use of the predefined configuration mechanism provides more flexibility, since it allows the operator to configure the configurations to be used after handover.

### SUMMARY OF THE PRESENT INVENTION

According to one aspect of the present invention, there is provided a method to avoid unnecessary re-acquisition of preconfiguration information upon change to an equivalent PLMN.

### BRIEF DESCRIPTION OF TEE DRAWINGS

FIG. 1 illustrates UTRAN and GSM access to a core radio network; and

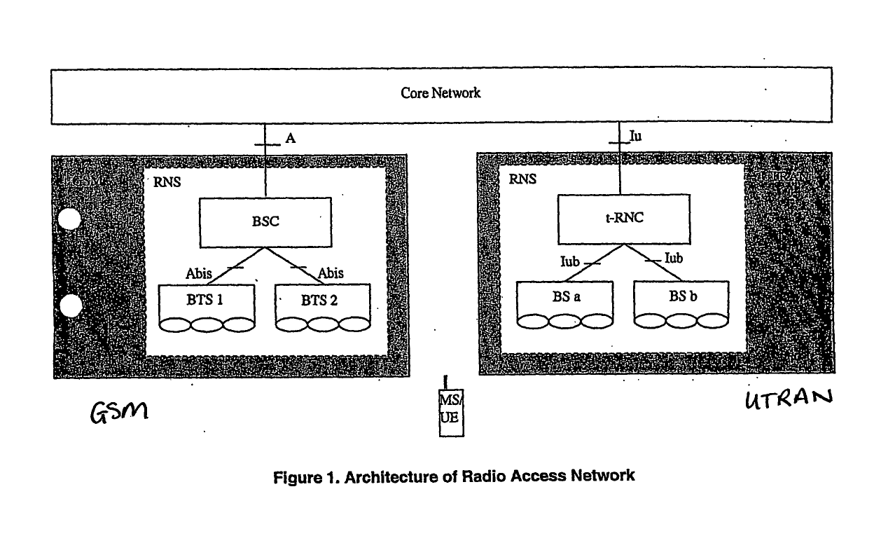

FIG. 2 illustrates handover from GSM to UTRAN.

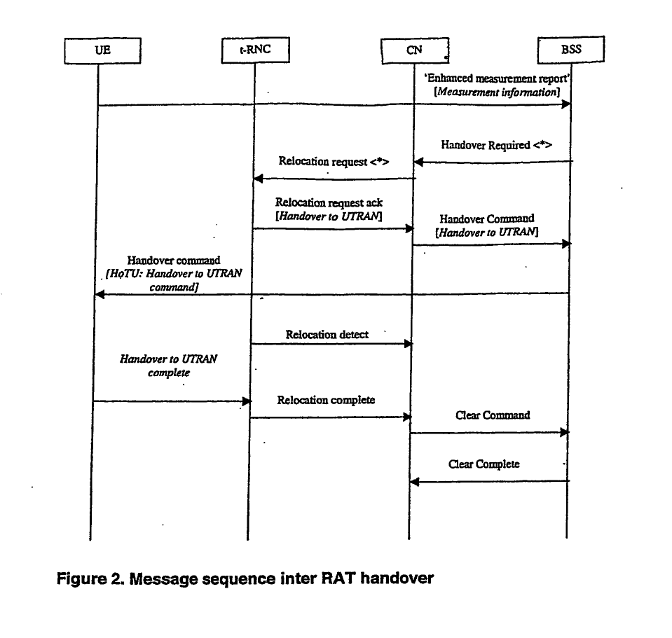

### DETAILED DESCRIPTION

In an embodiment of the present invention, a flag is added to each preconfiguration broadcast to indicate whether or not the preconfiguration is valid only for the current PLMN or also for all equivalent PLMNs.

This flag makes it possible to determine which pre-defined configurations are valid for all equivalent PLMNs. This means that these pre-defined configurations do not need to be re-acquired upon change to an equivalent PLMN.

Preferably, in order to minimise the changes to the current principles and procedures for each pre-defined configuration that is valid for all equivalent PLMNs, the same preconfiguration identity and value tag should be applied in all equivalent PLMNs.

It is not needed that all PLMNs broadcast the same version of a preconfiguration. However, for a certain preconfiguration value tag 1 should correspond with the same version in all equivalent PLMNs. Moreover, the procedures for informing the target RNC about the pre defined configurations stored in the UE are preferably enhanced to support equivalent PLMNs, as follows:

A UE connected to GSM is able to read/verify the PLMN identity from the UMTS cell, from which it also reads predefined configuration information

For each preconfiguration read from the UMTS neighbouring cells while connected to GSM, the following applies:

in the case when the information is valid only for the PLMN concerned, the UE stores, together with the information, the PLMN identity for the cell from which it was read

in the case when the information is valid also for the equivalent PLMNs, the UE stores, together with the information, the PLMN identity for the cell from which the information was read as well as the equivalent PLMNs

In one embodiment, the procedure used by the BSC to determine which pre-defined configuration information is stored in the UE is extended as follows:

The network shall be able to request the UE to report which pre-defined configurations it has stored that are relevant for a certain PLMN. The network invokes this function by including the PLMN identity of the target cell in the request in case the network does not include a PLMN identity in the request, the UE shall report all preconfigurations relevant for the PLMN it is currently connected to

In addition, the network may request the UE to report all stored pre-defined configuration information, in which case the mobile shall indicate for each information for which PLMN(s) it is valid. For preconfigurations that are valid also for equivalent PLMNS, the UE shall indicate the PLMN identity of one of the equivalent PLMNs.

In order not to delay the handover procedure, it is desirable to have the preconfiguration information available beforehand. Therefore, the network may request pre-configuration status information in conjunction with the LA/RA procedure or when the network orders measurements when in dedicated GSM mode

The UE shall indicate changes concerning the status of which pre-defined configuration are stored only when the changes are relevant for the PLMN(s) that the network has requested information for

When initiating handover to UTRAN, the source BSC reports the preconfigurations valid for the PLMN of the target cell

The flag indicating if the preconfiguration is valid for the PLMN where it was read or also for all equivalent PLMNs can normally be read together with the preconfiguration information. This information can be broadcast by UTRAN cells within System Information Block (SIB) 16.

Currently preconfiguration can only be downloaded via system information. However, it is possible that in future predefined configurations are assigned by means of dedicated messages. In that case, the flag indicating whether the preconfiguration is valid for equivalent PLMNs should be transferred together with the preconfiguration information in the same dedicated message.

In order to be backwards compatible, the UE should preferably interpret absence of the flag information as if the preconfiguration information is valid only for the PLMN where it was read.

Even when connected to GSM, the UE can determine the PLMN identity of the UTRAN cell from which the preconfiguration information was read.

If used, the network provides the information about equivalent PLMNs to the UE by means of MM specific procedures.

When the UE changes to an equivalent PLMN, it shall discard the preconfigurations that are valid only for the previous PLMN. If however the UE changes to another (ie. non-equivalent) PLMN, it shall discard all preconfigurations.

The UE need not discard the information; it should merely mark the information as invalid. The UE may re-use the information upon re-entering the PLMN.

The above-described embodiments are intended to address the problem of reading the same pre configuration data after an Inter PLMN cell selection/reselection. As long as the mobile is doing a cell selection/reselection/handover between PLMNs belonging to the same equivalent PLMN the BSC shall regard the pre-configuration data once read in one of the PLMN in the equivalent PLMN as valid as long as the mobile stays in the equivalent PLMN. Once requested the network has the knowledge of the preconfiguration of the mobile in that equivalent PLMN.

The current problem is that BSC has no knowledge of Equivalent PLMN and in case of handover to a PLMN not belonging to the Equivalent PLMN the mobile is preconfigured to the old PLMN. Instead of the BSC after each inter PLMN handover requesting the preconfiguration from the mobile the BSC receives information if the mobile is preconfigured according to the new PLMN. This information is given to the BSC by the core network, typically in the handover signalling. The BSC will use this TYPE OF HANDOVER FLAG indication to decide if the mobile shall be requested for preconfiguration or not after an inter PLMN handover.

TYPE OF HANDOVER FLAG added to ANDOVER REQUEST signalling as a new parameter or added to the container (GSM today OLD BSS TO NEW BSS).

Although it has been described that the pre-configuration is always valid if cell selection/cell reselection/handover has been performed within the equivalent PLMN, this will not always be the case due to the validity period for a read preconfiguration, which is today in standard set to 6 h. By indicating a time stamp to the network the network may judge when the preconfiguration data for the mobile is no longer valid.

Time Validity Period for preconfiguration sent in UTRAN CLASSMARK Change.

UEs can avoid the cumbersome and time consuming re-reading of preconfiguration from system information upon change of PLMN within a virtual PLMN set. This improves battery consumption and timely availability of preconfiguration information within the UE

The flexible concept defined allows operators to agree a common set of preconfigurations as well as to use a set of operator specific ones.

An alternative to re-acquisition is to keep preconfigurations related to other PLMNs in UE memory. If this approach is used, emobodiments of the inventions enable less UE memory to be used to handle equivalent PLMN scenarios.

Embodiments can also provide:

A method to avoid unnecessary re-acquisition of preconfiguration upon change to an equivalent PLMN.

A method to detect if a stored preconfiguration in the mobile is valid for the inter system handover

A method to control re-reading of already stored preconfiguration information

A method to shorten handover times for inter RAT handovers.

1. A method of configuring a mobile terminal, in which configuration information is transmitted to the mobile terminal from a first communications network, the configuration information relating to the first communications network and including an indication as to whether the information is valid for the first communications network only or for all communication networks equivalent to the first communications network.

2. A method of configuring a mobile terminal in which configuration information relating to a first communications network is stored in the mobile terminal, the configuration information including an indication as to whether the information is valid for the first communications network only or for all communication networks equivalent to the first communications network.

3. A method as claimed in claim 1 or 2, wherein the communications networks are wireless networks.

4. A method as claimed in claim 3, wherein the communications networks are Public Land Mobile Networks (PLMNs).

5. A method as claimed in any one of the preceding claims, wherein the configuration information is used for communication with a second network.

6. A method as claimed in claim 2, wherein the mobile terminal indicates to the network which configuration information is available.

7. A method as claimed In any one of the preceding claims, wherein configuration information for a plurality of networks is transmitted or stored.

8. A method of handover of a mobile device from a first mobile communications network to a second mobile communications network, the mobile device storing configuration information, the method comprising:
requesting handover to the second network;
determining whether the stored preconfiguration Information relates to the second network, the preconfiguration information including an indication as to whether the information is valid for the first communications network only or for all communications networks equivalent to the first communications network; and
communicating with the second network using the stored preconfiguration information, if that information relates to the second network.
